(19) United States
(12) Patent Application Publication
(10) Pub. No.: US 2009/0288003 A1
(43) Pub. Date: Nov. 19, 2009

(54) Cost effective system and method for monitoring machinery units

(76) Inventor: Sinisa V. Marinkovic, Skokie, IL (US)

Correspondence Address: Olson & Cepuritis, LTD., 20 NORTH WACKER DRIVE, 36TH FLOOR, CHICAGO, IL, 60606, US

(21) Appl. No.: 12/227,751

(22) PCT Filed: May 31, 2007
(86) PCT No.: PCT/US07/12798

§ 371 Date: Jun. 2, 2009

Related U.S. Application Data
(60) Provisional application No. 60/810,067, filed on May 31, 2006.

(51) Int. Cl. G05B 15/02; G06F 3/048; G06F 15/00

(52) U.S. Cl. 715/708; 700/7; 702/182; 715/772

(57) ABSTRACT

The present software and hardware system provides monitoring and adaptive operator communication and software for a plurality of machinery units (12) such as machine tools in a shop floor or factory environment. The monitoring system includes a data acquisition processor (16) including a read-only measurement input bank (22), a computer (18) with a general purpose operating system in electronic communication with the data acquisition processor (16), and a plurality of controller-isolated operator terminals (20) operably connected to the computer (18). The input bank (22) is adapted for connection to monitoring sensors (24) or other measuring devices operably positioned or secured to the machinery units (20). The computer (18) and the plurality of controller-isolated operator terminals (20) partially define a local-area network.

### FIELD OF THE INVENTION

The invention generally relates to the field of automation, and more specifically to systems and methods for the monitoring of multiple machinery units such as automated machine tools and the like with incompatible control systems.

### BACKGROUND OF THE INVENTION

Machine tools were among the first group of industrial machines to be automated with computers and related electronics. Machine tools are conventionally equipped with a control system to process an electronic file of instruction codes that dictate machine activity. While industry-wide standards have been adopted for machine tool instruction codes, e.g., the “G-code” EIA-274-D standard, the approach to implementing the instruction code standards varies. The manufacturing of machine tools remains widely distributed among several companies, each employing different, proprietary control electronics.

For example, many machine tool manufacturers offer some type of interface option for real-time communication between tool controls and a general purpose computer. Such options are typically expensive, however, and not adopted into any industry standard. Although otherwise useful, older machine tools are often equipped with control systems that altogether lack a computer interface. To form work cells of multiple machine tools, shop floor operators are often constrained into purchasing new tools manufactured by the same manufacturer in order to provide the necessary intercommunication among controls.

In general, attempts to offer central data-acquisition and monitoring of multiple machine tools have not extended beyond an individual machine tool manufacturer. Currently available integration schemes for multi-source machine tools are equipment invasive, highly customized projects, and therefore, expensive to own. Even today's best efforts at centralized data gathering and integration result in fixed, inflexible systems that require dedicated, system-trained staff for maintenance and shop floor changes such as adding a new machine tool. A related problem is that tool manufacturers limit shop-floor access to internal elements of machine tool electronics with warranty restrictions and the like.

It would be desirable to provide a monitoring system that both accommodates machinery units such as machine tools and the like with separate proprietary control systems and directs related shop floor operating data to commercially standard computer systems.

### SUMMARY OF THE INVENTION

Monitoring systems of the present invention provide monitoring and operator communication for multiple machinery units via commercially standard computer hardware and software. The systems according to the present invention are read-only with respect to any control electronics integrated with the system to be monitored and, therefore, are usable with controls of varying configurations. Illustrative such machinery units are machine tools, stamping presses, packaging systems, air conditioning units, and the like.

In a preferred embodiment, the present invention provides a monitoring system for a plurality of machine tools each having an integrated controller with a feedback measurement input to the controller. The monitoring system embodying the present invention includes a data acquisition processor including a read-only measurement input bank, a computer with a general purpose operating system in electronic communication with the data acquisition processor, and a plurality of controller-isolated operator terminals operably connected to the computer.

The input bank is adapted for connection to monitoring sensors or other measuring devices operably positioned or secured to the machinery units such as machine tools. The computer and the plurality of controller-isolated operator terminals partially define a local-area network.

### BRIEF DESCRIPTION OF THE DRAWINGS

In the accompanying drawings that form part of the specification, and in which like numerals are employed to designate like parts throughout the same,

FIG. 1 is a schematic block diagram illustrating a monitoring system for a group of machine tools according to the present invention;

FIG. 2 is a data record definition diagram illustrating the type and grouping of data recorded and processed by monitoring systems according to the present invention; and

FIG. 3 is a schematic block diagram illustrating the software components serving an operator advisor module running and resident on the computer network.

### DETAILED DESCRIPTION OF PREFERRED EMBODIMENTS

The invention disclosed herein is, of course, susceptible of embodiment in may different forms. Shown in the drawings and described herein below in detail are preferred embodiments of the invention. It is to be understood, however, that the present disclosure is an exemplification of the principles of the invention and do not limit the invention to the illustrated embodiments.

In the FIGURES, a single block or cell may indicate several individual software and/or hardware components that collectively perform the identified single function. Likewise, a single line may represent several individual signals or several instances of software data sharing or interconnection.

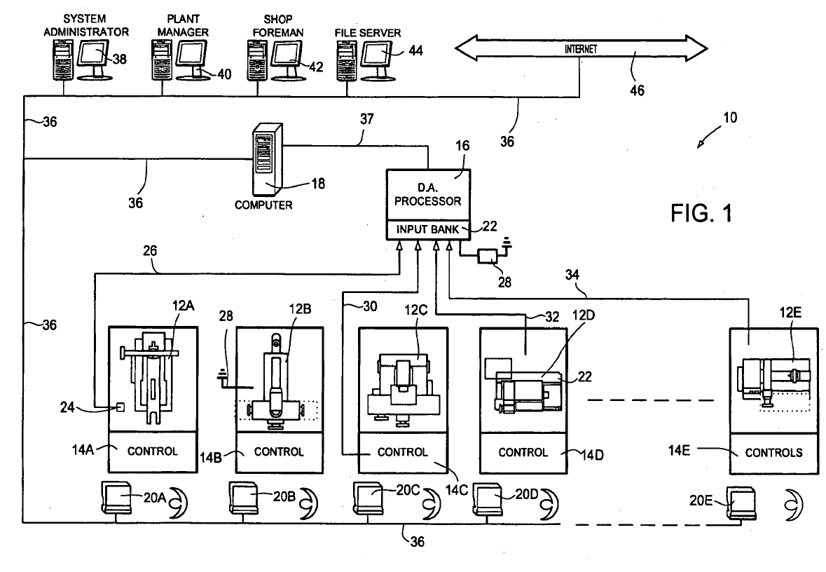

Referring to FIG. 1, the elements of a machine tool monitoring system 10 are shown with a series of CNC machine tool work centers including a shaping machine 12A, a vertical milling machine 12B, a surface grinder 12C, a lathe 12D and a center lathe 12E. Each machine tool 12A, 12B, 12C, 12D, 12E is equipped with corresponding controls 14A, 14B, 14C, 14D and 14E, respectively. Monitoring system 10 includes a data acquisition processor 16, a computer 18 and a series of operator terminals 20A, 20B, 20C, 20D and 20E.

Data acquisition processor 16 preferably includes a hardware and software combination designed for real-time applications. The data acquisition processor provides for substantially uninterruptible execution of data acquisition. In a preferred embodiment, data acquisition processor 16 is a programmable logic controller (PLC). Suitable programmable logic controllers are commercially available from the Allen-Bradley Division of Rockwell Automation (Milwaukee, Wis.), Schneider Automation Inc. (North Andover, Mass.), Siemens Energy & Automation, Inc. (Alpharetta, Ga.) and SoftPLC (Spicewood, Tex.). Other real-time configurations not conventionally labeled “PLCs,” such as other DSP-based computers are also suitable for providing data acquisition processor.

Data acquisition processor 16 includes an input bank 22 which is configured to receive a series of measurement inputs. A key feature of the present invention is the configuration of read-only measurement inputs which are used for data acquisition but not direct control of machine tool operation.

The read-only measurements are preferably non-invasive to the machine tool mechanisms and integrated controls. For example, a monitoring sensor such as an optical sensor 24 is secured to or positioned adjacent to shaping machine 12A. Optical sensor 24 is positioned to detect lighted operation status indicators on shaping machine 12A. Signals from sensor 24 are directed to input bank 22 by a wired connection 26, though fiber optics and wireless communications are also contemplated.

For example, read-only measurements from CNC vertical milling machine 12B are directed to input bank 22 by a wireless communication link 28. Such wireless input connections may be preferred to reduce shop floor cross wiring and for the monitoring of machine tools remote to the data acquisition processor. Both radio frequency (RF) and infrared wireless transmission are contemplated. Another alternative to wired interconnection is represented by measurement inputs 30, which are provided from CNC lathe 12D via a fiber optic connection.

As necessary, monitoring systems according to the present invention share sensors and measurements with the integrated controls of the machine tools. For example, an input connection 32 drawn from integrated controls 14C of CNC surface grinder 12C provides a tool actuator position measurement to data acquisition processor 16. Accordingly, actuator position input 32 is provided to monitoring system 10 by “tapping” into an preexisting measurement signal provided to controls 14C.

To the extent the measurement inputs received at input bank 22 are otherwise non-invasive, preferred embodiments of the present invention include surveillance with monitoring sensors redundant to those separately functioning between the machine tools and the integrated controls. For example, center lathe 12E includes a vibration tachometer sensor (not separately indicated) operating between center lathe 12E and integrated controls 14E. Monitoring system 10 includes a redundant, vibrational tachometer input 34 for tracking operating activity at center lathe 12E without customizing the configuration of CNC controls 14E.

Although embodiments of the present invention include a data acquisition processor 16 with long-term data storage, preferred embodiments rely on computer 18 or other computers on network 36 to provide long-term data storage and permanent archiving. Accordingly, measurement time series and tool event activity data are collected and stored by data acquisition processor 16 and either continuously or intermittently transferred to computer 18. Computer 18 preferably operates with a general purpose operating system. The phrase “general purpose operating system” is a reference to commercially standard operating systems such as those available from the Microsoft Corp. under the designations Windows XP®, Windows NT® and Windows 2000®. Other examples of general purpose operating systems include Macintosh® (Apple Computers, Inc.), UNIX (various resellers) and Open VMS (Compaq Computer Corporation).

A variety of data transfer mechanisms are available to provide electronic and software-level communication between data acquisition processor 16 and computer 18. A commercially standard network or data bus backplane are preferred. The data bus connection is symbolically represented in FIG. 1 by reference numeral 37. A closed, proprietary interconnection is also contemplated. Suitable communication standards can be selected from the group consisting of an ISA bus, a PCI bus, a VME bus, a universal-serial-bus (USB), an Ethernet connection, other TCP/IP, and the like.

Operator terminals 20A through 20E are preferably PCs adapted for factory environments and operably linked to computer 18 in a local computer network 36. Also resident on network 36 are computer stations for manufacturing scheduling and administration. These include, by way of example, a system administrator computer 38, a plant manager station 40, a shop foreman station 42 and one or ore file servers 44. These administrative work stations 38 through 44 receive or have access to both archived and real-time machine tool data acquired via digital acquisition processor 16 and input bank 22.

Although network 36 is shown FIG. 1 as part of a connection chain for simplified illustration, the architecture of network 36 takes the form of one or more hub-and-spokes using network switches and/or routers (not separately shown). In addition, one or more segments of network 36 are implemented using wireless communication as desirable depending upon distance-from-office space and other shop floor infrastructure constraints.

A key feature of the present invention is that operator terminals 20A through 20E are substantially isolated from controller electronics. More specifically, operator terminals 20A through 20E are positioned near machine tool work centers 12A through 12E but isolated from the electronics in the corresponding controls 14A through 14E. While system 10 as illustrated includes an operator station for each machine tool work center, it is contemplated that multiple machine tool centers may share a nearby operator station.

A further key feature of the present invention is the accommodation of remote access to shop floor operation data and scheduling via wide access communication network. As indicated with reference number 46 in FIG. 1, the Internet is currently the preferred as the most widely available data access network. The present invention necessarily applies to a variety of wide access data networks, however, including private subscription networks, e.g, telecom dedicated T1, company intranets, and national data network utilities (e.g., France's Minitel network). Via an interface to a the Internet or similar wide-access network, manufacturing managers can access operating data and remotely manage job flows and schedules. Such access is provided at reduced risk because system 10's interaction with machine tool work centers 12A through 12E is read-only.

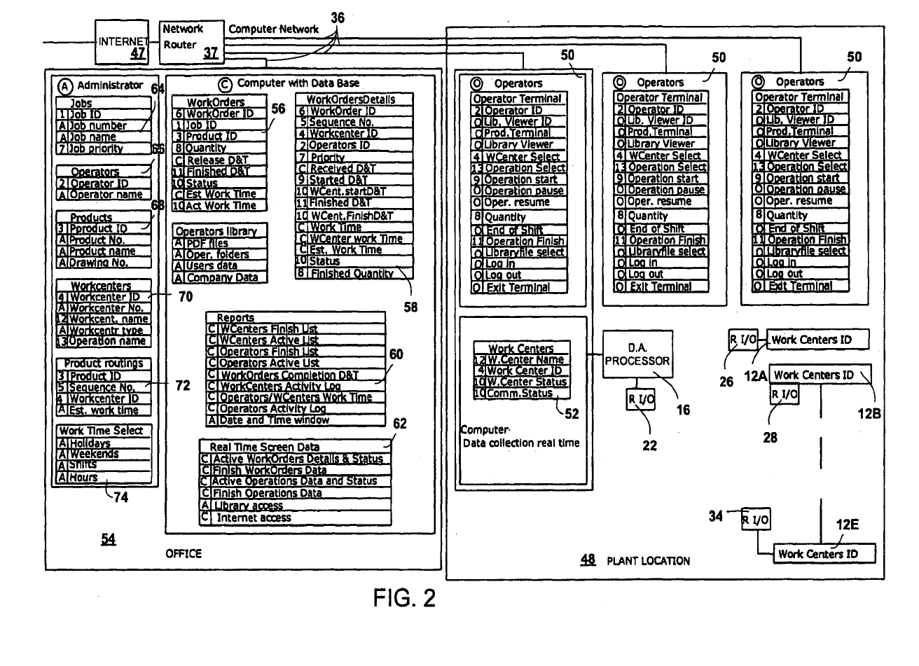

FIG. 2 contains a presentation of exemplary data record definitions for implementing a machine tool monitoring system according to the present invention. The record definitions are divided into groups according to the relative location where events are logged and data is collected. One group of data records 48 are associated with the plant location. These include operator terminal definitions 50, machine tool work center input definitions 52. Operator terminal definitions 50 are representative of the type of data and events logged and selectively displayed at operator terminals.

Another grouping of data record definitions 54 relates to factory management or administration such that these definitions are associated with an office or other remote location. These records include a general work order definition 56, a detailed work order definition 58, an operational report definition 60 and a real-time data screen display definition 62. Also included in group 54 are further base-level administrative record definitions such as a jobs definition 64, an operator identification definition 66, a product definition 68, a work center record definition 70, a product routing definition 72 and a work calendar definition 74.

Also represented in FIG. 2 are elements of system 10 in conjunction with corresponding data records. Data acquisition processor 16 provides real-time data from input bank 22 which is formatted according to record definition 52. Machine tool work centers 12A, 12B and 12D are represented with corresponding read only measurements. As described above, network 36 has hub-with-spoke segments including a router switch 37 and an Internet gateway 47.

The term “module,” as used herein refers to a software element such as a program, subprogram, software process, subroutine, or grouping of code segments and the like. The software modules of monitoring system 10 are preferably discrete executable programs which run as discrete processes. Unless otherwise indicated, the software modules and code segments are configured to share access to a variety of software variables and constants as needed through subroutine calls, common shared memory space, and the like. Without implying a limitation, modules are implemented among a variety of software formats according to efficiency, including compiled source code languages such as C, C++, BASIC, Java, Pascal, and Fortran; scripting languages such as JavaScript, Visual Basic, VBScript, Tcl, JScript, Python; commercially available database scripts; and hypertext markup language (HTML) for user.

With reference to both FIGS. 1 and 2, it is a significant feature of monitoring systems according to the present invention that modules, code segments and data may be stored on various elements throughout network 36. In one configuration of system 10, database records are maintained on computer 18 and archived on file server 44 while monitoring system-related executable modules are systematically mimicked among operator terminals (20A through 20E) and administrative stations (38 through 44). It is also contemplated that all modules may be centrally stored on server 44 or computer 18 and then executed remotely over network 36.

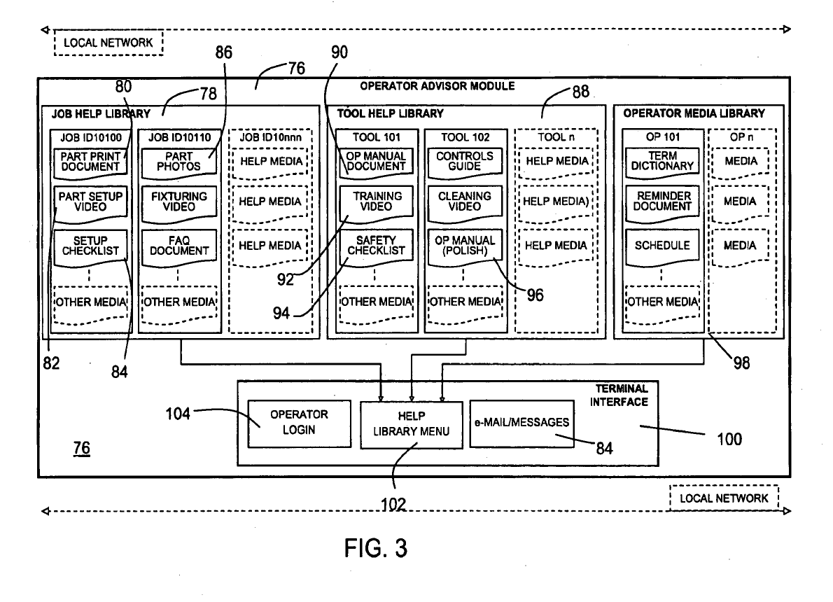

Further features of monitoring systems embodying the present invention are provisions for tool and job-specific help communication to operators via the operator terminals. An implementation of this adaptive automated operator assistance is illustrated symbolically in FIG. 3. An operator advisor module 76 available at stations throughout network 36 includes media help libraries arranged according to machining job, tool work center and individual operator. Supported media forms and formats are limited only by computer rendering capabilities and currently include both fixed and interactive audio messages, video presentations with sound, text documents, graphic documents, and photographs.

As shown in FIG. 3, a job-related media library 78 includes help files organized according to machining job such as a part print PDF document 80, a setup video instruction file 82, an interactive checklist script 84, a part photograph 86, etc. Job related media library 78 contains files to aid operators in completing a particular part or a particular machine step, i.e., a machining job.

A work center or tool-related media library 88 includes operator help files organized according to machine tool work center. Exemplary tool-related help files are a tool operation manual 90, a general tool training video 92, a safety review 94 which may be mandatory, and alternate language media such as an operating manual in the Polish language 96.

An operator-specific library 98 provides selective access to information of special interest to a given tool operator. Such operator specific media files may be requested or saved by the operator or provided by administrators according to special needs.

While selected help files may be shared among the job (78), tool (88) and operator (98) libraries, the help files are preferably shorted according these general categories. Operator advisor module 76 includes a user interface 100 with a menu code segment 102 which produce file selection menus at operator terminals 20A and 20E according to which a job, machine tool work center and individual operator have been identified via a login code segment 104. When a tool operator “logs in” and further provides a tool center selection and job or part selection, menu code segment 102 selects the appropriate files among the media libraries 78, 88 and 98 to provide a special menu of available help files.

The present monitoring system is not only well suited for use with machine tools but is equally well suited for use with other types of machinery units such as stamping presses, packaging machines, filling machines, air conditioning units, and the like.

The foregoing specification and drawings are to be taken as illustrative but not limiting of the present invention. Still other configurations and embodiments utilizing the spirit and scope of the present invention are possible, and will readily present themselves to those skilled in the art.

I claim:

1. A monitoring system for a plurality of machinery units having an integrated controller and a feedback measurement input to said controller, the monitoring system comprising:
a data acquisition processor including a read-only measurement input bank adapted for connection to a first machinery unit and a second machinery unit, said first and second machinery units having separate controller configurations;
a computer with a general purpose operating system in electronic communication with said data acquisition processor; and
a plurality of controller-isolated operator terminals operably connected to said computer, said computer and said plurality of controller-isolated operator terminals partially defining a local-area network.

2. The system of claim 1 further comprising a controller-isolated monitoring sensor adapted for measuring an activity of said first or said second machinery unit, said monitoring sensor being operably connected to said input bank.

3. The system of claim 2 wherein the controller-isolated monitoring sensor is operably linked to said input bank by a connection type selected from the group consisting of an electromagnetic wireless connection, an infrared wireless connection and a fiber optic connection.

4. The system of claim 1 further comprising a non-invasive monitoring sensor operably connected to said input bank and secured to said first machinery unit for measuring an activity of said first machinery unit.

5. The system of claim 4 wherein said monitoring sensor is of a type selected from the group consisting of an optical sensor, a vibrational sensor and a magnetic position sensor.

6. The system of claim 4 wherein said sensor provides a measurement redundant to said feedback measurement input of said first machinery unit.

7. The system of claim 1 further comprising a supplemental connection between said feedback measurement input and said input bank.

8. The system of claim 1 wherein the machinery unit is a machine tool and further comprising an operator advisor module running on said network, said operator advisor module including a library of operator help media files, a tool identifier variable, a current job variable, and a library of help media files.

9. The system of claim 8 wherein said operator advisor module includes a media-menu code segment for providing operator access to a selection of operator help media at said plurality of operator terminals according to said tool identifier variable and said current job variable.

10. The system of claim 1 further comprising operator help media stored on said network, said help media being sorted into job-related help library and a tool-related help library.

11. The system of claim 10 wherein said operator help media is stored on one of said plurality of operator terminals.

12. The system of claim 10 wherein said operator help media is stored on said computer.

13. The system of claim 10 wherein said operator help media is of a type selected from the group consisting of an electronic document, a video recording, a sound recording, and a combination thereof.

14. The system of claim 1 wherein said general purpose operating system is a member of the group consisting of a Unix, a Windows-XP®, a Windows 2000®, a Windows-NT®, a Windows 98®, a Windows 95®, an Open VMS®, a PC/MS DOS.
